(19) United States
(12) Patent Application Publication
(10) Pub. No.: US 2009/0046750 A1
(43) Pub. Date: Feb. 19, 2009

(54) INCREASED NANOSECOND LASER PULSE-TO-PULSE ENERGY REPEATABILITY USING ACTIVE LASER PULSE ENERGY CONTROL

(76) Inventors: JIPING LI, Palo Alto, CA (US); Timothy N. Thomas, Portland, OR (US); Dean Jennings, Beverly, MA (US); Bruce E. Adams, Portland, OR (US); Aaron Muir Hunter, Santa Cruz, CA (US)

Correspondence Address: PATTERSON & SHERIDAN, LLP - - APPM/TX, 3040 POST OAK BOULEVARD, SUITE 1500, HOUSTON, TX, 77056, US

(21) Appl. No.: 11/839,415

(22) Filed: Aug. 15, 2007

(51) Int. Cl. H01S 3/10

(52) U.S. Cl. 372/25

(57) ABSTRACT

A method and apparatus for reducing the pulse-to-pulse laser energy variation (i.e., increasing the pulse-to-pulse laser energy repeatability) from a pulsed laser source are provided. In this manner, laser pulses impingent on a processing plane, such as the surface of a wafer or other substrate, may have substantially the same energy content leading to a more controlled process when compared to conventional processing. The method may be based on in-situ detection of the pulse energy level and the subsequent active adjustment of the transmitted laser pulse energy in a closed-loop control scheme. Furthermore, the active adjustment of the laser pulse energy may occur within a few nanoseconds after the original laser pulse is generated by a pulsed laser source.

### BACKGROUND OF THE INVENTION

1. Field of the Invention

Embodiments of the present invention generally relate to laser annealing and, more particularly, to a method of reducing the pulse-to-pulse laser energy variation from a pulsed laser source.

2. Description of the Related Art

The integrated circuit (IC) market is continually demanding greater memory capacity, faster switching speeds, and smaller feature sizes. One of the major steps the industry has taken to address these demands is to change from batch processing silicon wafers in large furnaces to single wafer processing in a small chamber.

During such single wafer processing the wafer is typically heated to high temperatures so that various chemical and physical reactions can take place in multiple IC devices defined in the wafer. Of particular interest, favorable electrical performance of the IC devices requires implanted regions to be annealed. Annealing recreates a more crystalline structure from regions of the wafer that were previously made amorphous, and activates dopants by incorporating their atoms into the crystalline lattice of the substrate, or wafer. Thermal processes, such as annealing, require providing a relatively large amount of thermal energy to the wafer in a short amount of time, and thereafter rapidly cooling the wafer to terminate the thermal process. Examples of thermal processes currently in use include Rapid Thermal Processing (RTP) and impulse (spike) annealing.

A drawback of RTP processes is that they heat the entire wafer even though the IC devices typically reside only in the top few microns of the silicon wafer. This limits how fast one can heat up and cool down the wafer. Moreover, once the entire wafer is at an elevated temperature, heat can only dissipate into the surrounding space or structures. As a result, today's state of the art RTP systems struggle to achieve a 400° C./s ramp-up rate and a 150° C./s ramp-down rate. While RTP and spike annealing processes are widely used, current technology is not ideal, and tends to ramp the wafer temperature during thermal processing too slowly and thus expose the wafer to elevated temperatures for too long a period of time. These thermal budget type problems become more severe with increasing wafer sizes, increasing switching speeds, and/or decreasing feature sizes.

To resolve some of the problems raised in conventional RTP-type processes, various scanning laser anneal techniques have been used to anneal the surface(s) of the substrate. In general, these techniques deliver a constant energy flux to a small region on the surface of the substrate while the substrate is translated, or scanned, relative to the energy delivered to the small region. Due to the stringent uniformity requirements and the complexity of minimizing the overlap of scanned regions across the substrate surface these types of processes are not effective for thermal processing contact level devices formed on the surface of the substrate.

Pulsed laser anneal techniques have been used to anneal finite regions on the surface of the substrate to provide a well defined annealed and/or re-melted regions on the surface of the substrate. In general, during a pulsed laser, anneal processes various regions on the surface of the substrate are exposed to a desired amount of energy delivered from the laser to cause the preferential heating of desired regions of the substrate. Pulsed laser anneal techniques have an advantage over conventional processes that sweep the laser energy across the surface of the substrate, since the need to tightly control the overlap between adjacently scanned regions to assure uniform annealing across the desired regions of the substrate is not an issue, since the overlap of the exposed regions of the substrate is typically limited to the unused space between die, or “kerf” lines.

Due to the shrinking semiconductor device sizes and stringent device processing characteristics the tolerance in the variation in the amount of energy delivered during each pulse to different devices formed on the substrate surface is very low. These device requirements are driving the tolerance to variations in the delivered energy across the exposed surface of the substrate to be rather small (e.g., <5% variation). However, commercially available pulsed laser sources, such as a Q-switched laser source, possess a flash lamp where electrons are pumped from the valence band to the induction band. This pump is not well-controlled in the Q-switched laser, and therefore, these conventional pulsed laser sources typically perform with an unacceptable pulse-to-pulse energy variation on the order of 10%.

Accordingly, what is needed is a technique for reducing the pulse-to-pulse energy variation (i.e., increasing the pulse-to-pulse laser energy repeatability) in a series of laser pulses delivered to a processing plane.

### SUMMARY OF THE INVENTION

Embodiments of the present invention generally relate to reducing the pulse-to-pulse laser energy variation (i.e., increasing the pulse-to-pulse laser energy repeatability) from a pulsed laser source.

One embodiment of the present invention is a method. The method generally includes generating a pulse of energy; measuring a characteristic of the pulse of energy; comparing the difference between the measured characteristic and a desired value using a control system; adjusting the characteristic of the pulse of energy based on the comparison using the control system; and transmitting the pulse of energy having the adjusted characteristic to a desired receiving component. The characteristic of the pulse of energy may be the shape of the pulse, the pulse width, the pulse peak value, or the total energy. The pulse of energy may be generated by any suitable type of electromagnetic energy source, such as an optical radiation source, an electron beam source, an ion beam source, or a microwave energy source

Another embodiment of the present invention is a method of sourcing a plurality of laser pulses having substantially the same energy. The method generally includes a) providing a series of input laser pulses; b) splitting one of the series of input laser pulses into a control loop pulse and a transmitted pulse; c) detecting the control loop pulse; d) comparing the detected control loop pulse with a reference signal; e) modulating a Pockels cell based on the comparison; f) delaying the transmitted pulse from reaching the Pockels cell by a delay greater than an amount of time taken in steps c-e plus about half a pulse width of the plurality of laser pulses; g) transmitting the delayed transmitted pulse through the modulated Pockels cell and a polarizing beam splitter (PBS) to provide an adjusted output pulse; and h) repeating steps b-g for each remaining input laser pulse in the series of input laser pulses such that each of the adjusted output pulses has substantially the same energy.

Yet another embodiment of the present invention provides an apparatus. The apparatus generally includes a laser source for providing a plurality of laser pulses; a beam splitter coupled to the laser source to provide a transmission optical path and a control loop optical path; an active control circuit coupled to the beam splitter along the control loop optical path; a means for delaying the plurality of pulses coupled to the beam splitter along the transmission optical path; and a Pockels cell coupled to the pulse delay means and controlled by the active control circuit such that the delayed plurality of pulses are adjusted to have substantially the same energy upon exiting the Pockels cell.

Yet another embodiment of the present invention provides a pulsed laser annealing system. The pulsed laser annealing system generally includes a laser source for providing a plurality of laser pulses; a beam splitter coupled to the laser source to provide a transmission optical path and a control loop optical path; an active control circuit coupled to the beam splitter along the control loop optical path; a means for delaying the plurality of pulses coupled to the beam splitter along the transmission optical path; a Pockels cell coupled to the pulse delay means and controlled by the active control circuit such that the delayed plurality of pulses are adjusted to have substantially the same energy upon exiting the Pockels cell; and a pedestal for supporting a substrate to be annealed by the adjusted plurality of pulses.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-C represent laser pulse shapes before and after active pulse energy control in accordance with embodiments of the invention.

FIG. 2 is a block diagram of the optics layout and closed-loop control of the laser pulses in accordance with an embodiment of the invention.

FIG. 3 is a flow diagram for reducing the pulse-to-pulse laser energy variation in a series of laser pulses in accordance with an embodiment of the invention.

FIGS. 4A-B illustrate detecting the laser pulse energy by using the detected pulse peak or the integral of the detected pulse over time in accordance with embodiments of the invention.

FIG. 5 is a block diagram of the threshold-crossing detection and trigger generation for the Pockels cell amplifier in accordance with an embodiment of the invention.

FIG. 6 is a schematic for a simple proportional-integral (PI) closed loop control circuit in accordance with an embodiment of the invention.

FIG. 7 illustrates an optical beam delay scheme in accordance with an embodiment of the invention.

FIGS. 8A-D are timing diagrams illustrating active laser pulse energy control and associated delays in accordance with embodiments of the invention.

### DETAILED DESCRIPTION

Embodiments of the present invention provide techniques and apparatus for reducing the pulse-to-pulse laser energy variation (i.e., increasing the pulse-to-pulse laser energy repeatability) from a pulsed laser source. In this manner, laser pulses impingent on a processing plane, such as the surface of a wafer or other substrate, may have substantially the same energy content leading to a more controlled annealing process when compared to conventional annealing. The technique may be based on in-situ detection of the pulse energy level and the subsequent active adjustment of the transmitted laser pulse energy in a closed-loop control scheme. Furthermore, the active adjustment of the energy in each laser pulse may occur within a few nanoseconds after the original laser pulse is generated by a pulsed laser source.

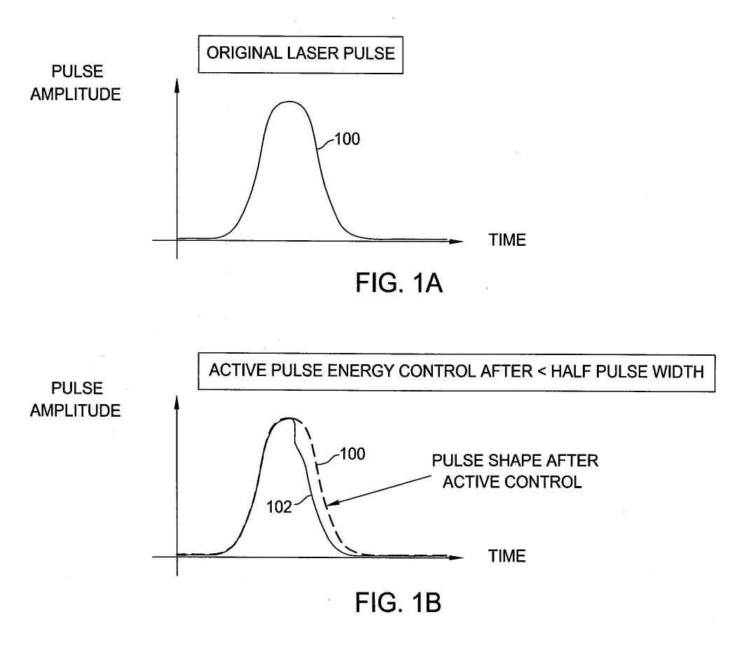

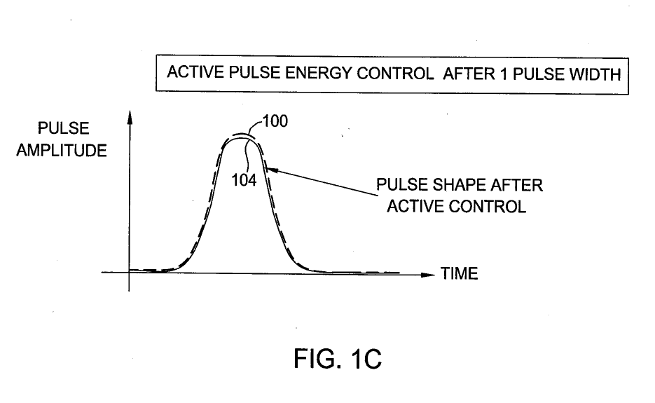

There may be a number of ways to actively control the energy content of a transmitted laser pulse. FIG. 1A illustrates an exemplary, Gaussian laser pulse 100 originally output by a laser source, such as a Q-switched pulsed laser. The pulse width may be on the order of 5 to 40 ns, and the amplitude or total energy (typically about 1 to 10 joules) may be originally set to any desired level depending on the capability of the laser source and the desired annealing process results. One active control method may involve detecting a percentage of the pulse peak (e.g., 90%) and then applying the active energy control before the pulse peak is reached as shown in FIG. 1B. Such detection should typically occur at less than half the pulse width. The dashed line represents the original laser pulse 100, and the solid line represents the pulse 102 after the active laser pulse energy control takes effect. Referring now to FIG. 1C, another active control method may entail applying the active energy control some time after one entire pulse width has elapsed to a delayed delivery of the laser pulse. Again in FIG. 1C, the dashed line represents the original laser pulse 100, and the solid line represents the pulse 104 after the active laser pulse energy control has been invoked.

Although techniques and apparatus disclosed herein may be described with respect to a laser annealing system, these techniques and apparatus may apply to any application where pulse-to-pulse laser energy repeatability is desired.

An Exemplary Active Laser Pulse Energy Control

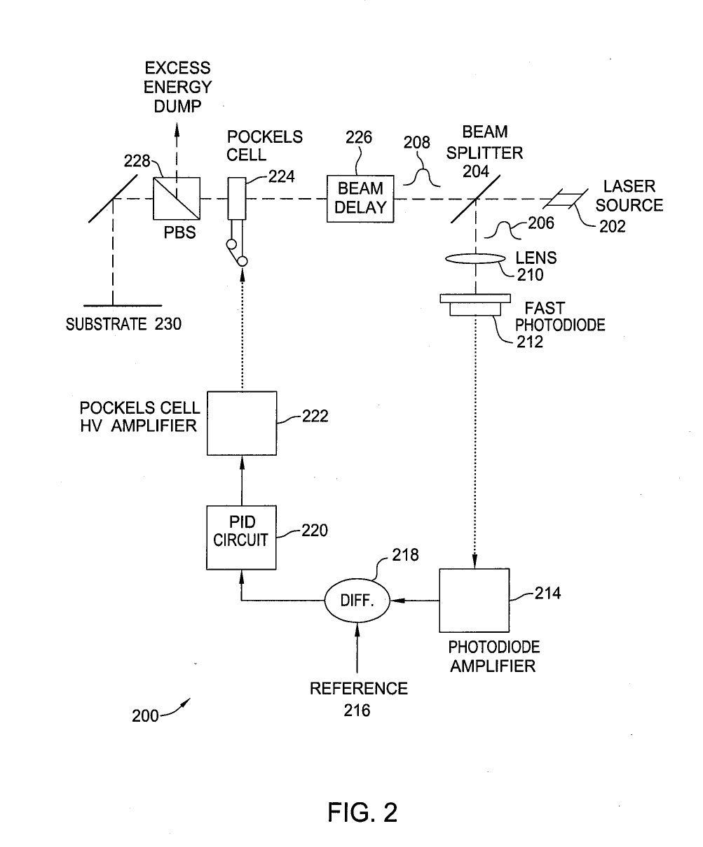

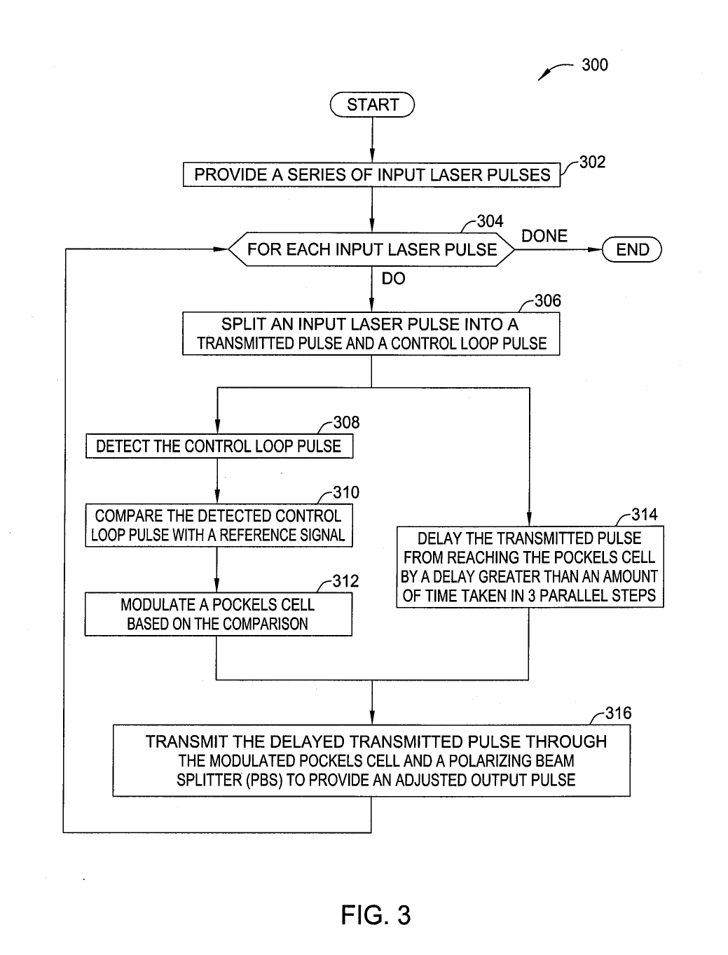

FIG. 2 is a block diagram 200 of the optics layout and closed-loop control of the laser pulses according to one embodiment of the invention. The block diagram 200 will be described in conjunction with the flow diagram 300 of FIG. 3 outlining the steps for reducing the pulse-to-pulse laser energy variation in a series of laser pulses.

In step 302, a series of laser pulses may be provided from a laser source 202, such as a Q-switched pulsed laser having a desired amplitude and pulse width. For laser annealing, the pulse width may be on the order of 5 to 40 ns, and the period of the pulses may be about 200 ms (i.e., a frequency of 5 Hz).

The laser source 202 may be adapted to deliver electromagnetic energy in the form of optical radiation that is used to preferentially anneal and/or melt certain desired areas of a substrate surface. In one embodiment, the laser source 202 may be configured to deliver energy at a wavelength less than about 1064 nm to a primarily silicon-containing substrate. In another embodiment, the laser annealing process may be performed on a silicon-containing substrate using radiation with a wavelength less than about 800 nm. In yet another embodiment, the wavelength of the electromagnetic energy delivered from the laser source 202 may be about 532 nm. In yet another embodiment, the wavelength of the electromagnetic energy delivered from the laser source 202 to the substrate may be about 216 nm or about 193 nm. For some embodiments, an Nd:YAG (neodymium-doped yttrium aluminum garnet) laser adapted to deliver energy at a wavelength between about 266 nm and about 1064 nm may be employed. In one such embodiment, the laser source 202 may be a single Nd:YAG laser configured to deliver energy between about 1 and 10 joules at a pulse width between about 6 ns and about 30 ns at a desired wavelength, such as 532 nm.

Starting with step 304, for each of the laser pulses provided by the laser source 202, a series of operations may be performed to adjust the energy level of the laser pulses so that all of the output laser pulses have substantially the same energy level (within a 5% pulse-to-pulse energy variation, or preferably within 2%).

A laser pulse output from the laser source 202 may be split in step 306 by a beam splitter 204 into two pulses: a control loop pulse 206 and a transmitted pulse 208. The control loop pulse 206, whose energy may be a small percentage of the original beam energy (e.g., 0.1% to < a few %), may be detected and converted from an optical signal into an electrical signal in step 308. For some embodiments, an optional lens 210 may be used to focus the control loop pulse 206 on the detection equipment, especially if the beam of the control loop pulse is large compared to a detection window of the detection equipment.

The detection equipment may consist of any suitable optical detection means for quickly converting an optical signal into an electrical signal, such as a high-speed photodiode 212, a charge-coupled device (CCD) camera, a fast energy meter, or any other suitable device capable of very fast energy sensing. The high-speed photodiode 212 may be coupled to an amplifier 214 to boost the detected signal amplitude for subsequent processing. In such cases, the amplifier 214 should be placed close to the high-speed photodiode 212 in an effort to reduce the coupling of electromagnetic interference (EMI) and other types of noise into the amplifier input where it can be received and amplified with the desired signal. In addition, the placement, orientation, and surrounding environment of the high-speed photodiode 212 may need to be carefully selected, taking into consideration potential sources of EMI and other noise.

In step 310 the signal from the detected control loop pulse may be compared to a predetermined reference 216, and the difference (i.e., an error signal) may be calculated by a difference determiner 218, such as an analog subtractor or differential amplifier. The error signal may be sent to a proportional-integral-derivative (PID) control circuit 220, PID being a well-known closed-loop control methodology to those skilled in the art.

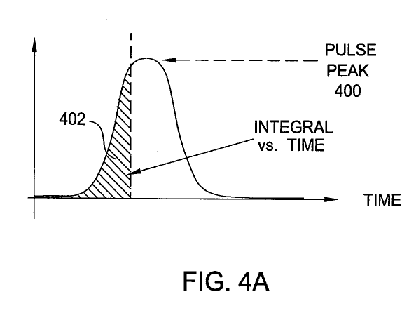

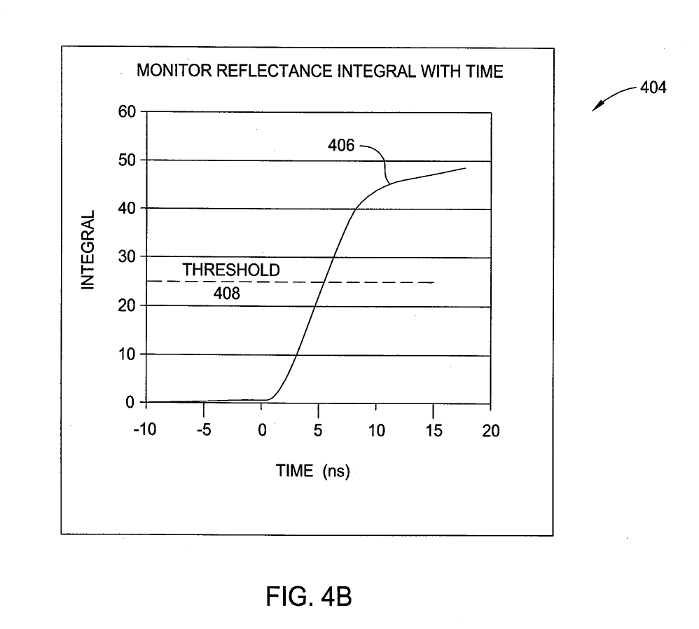

The detected signal may be processed in various ways to determine the laser pulse energy level. For some embodiments, the amplitude of the detected signal at a certain time may be used, while in other embodiments, the pulse peak value 400 as shown in FIG. 4A may be employed for comparing pulse energy levels. Ideally, the pulse peak value 400 should correlate well with the energy in each pulse and may offer a direct indication of the pulse energy. However, determining the pulse peak value 400 may require a wait time of at least half of the pulse width for a Gaussian or sinusoidal pulse in order to reach and detect the peak. Thus, another way to determine the laser pulse energy may be to integrate the detected signal, which essentially calculates the area 402 under the detected signal curve with time as shown pictorially in FIG. 4A. A typical graph 404 of the integral 406 versus time is illustrated in FIG. 4B. Use of the integral may improve the signal to noise ratio (SNR) when compared to the use of the detected signal amplitude or the pulse peak value 400 in step 310.

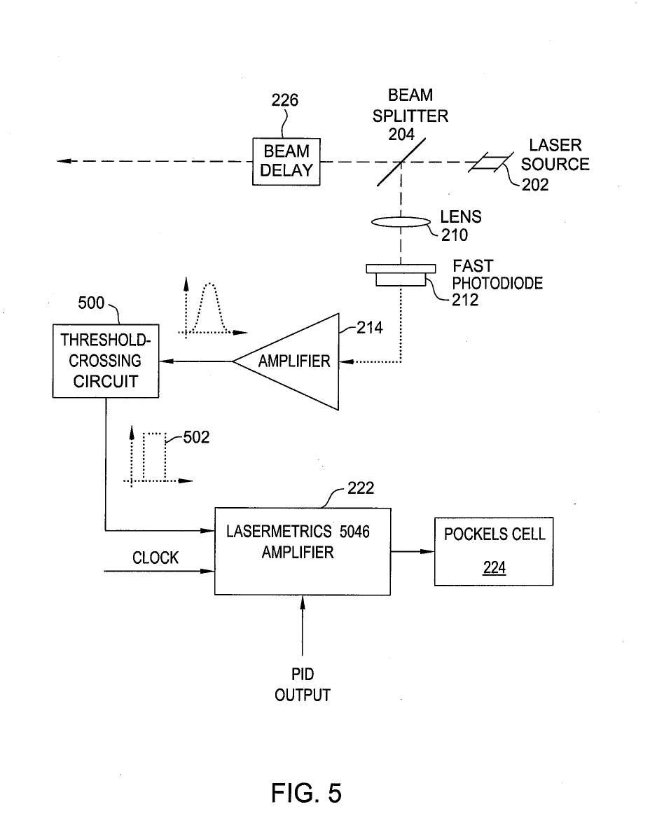

The threshold level 408 shown in FIG. 4B may be used as the reference 216 in the active control loop. For some embodiments as illustrated in FIG. 5, the threshold level 408 may be utilized as part of a threshold-crossing circuit 500 that generates a trigger signal 502 for the stages that follow once the integral 406 of the detected signal reaches the threshold level 408.

The PID circuit 220 may be realized through commercially available controllers for some embodiments. For other embodiments, the PID circuit 220 may be a model-based prediction circuit which calculates a control signal based on the sign and amplitude of the error signal. The PID circuit 220 may also be replaced by a simple polynomial summation circuit which generates the desired non-linear compensation voltage based on the error signal (differential signal between the detected signal and the reference signal 216). The coefficients of each of the polynomial terms may be variable gain amplifiers (VGAs) in the circuit for adjustment. These coefficients may be adjusted to obtain the desired compensation voltage versus error signal curve.

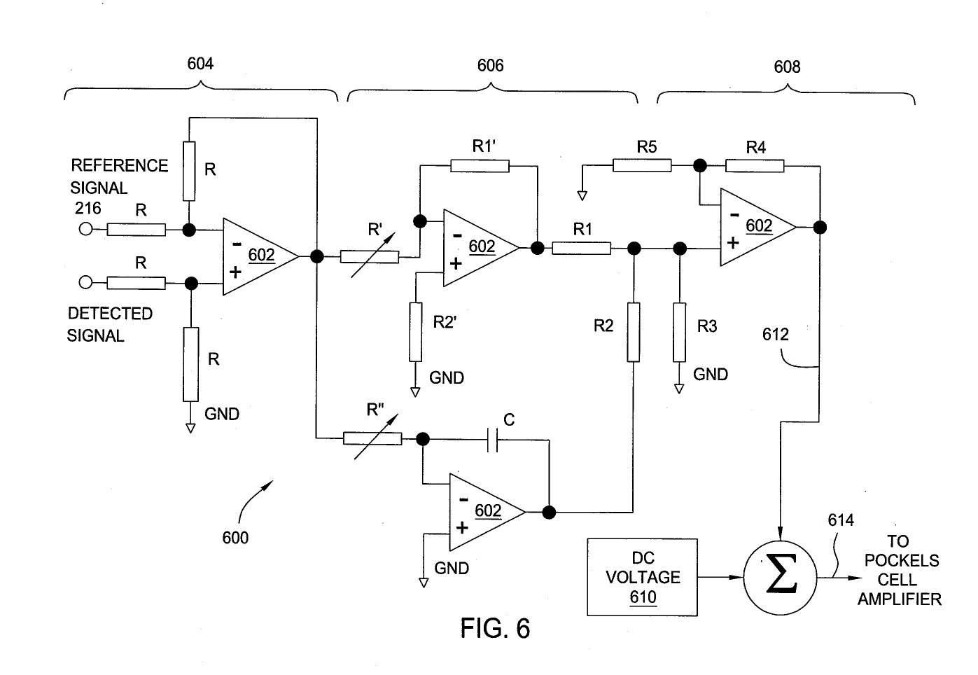

For still other embodiments, a simple, high-speed proportional or proportional-integral (PI) circuit 600 as depicted in FIG. 6 may be employed. The operational amplifier 602 in the differential amplifier 604, integrator 606, and buffer 608 stages may be high slew rate, current feedback amplifiers with short settling times (on the order of a few nanoseconds), such as the AD8003 1.5 GHz Op Amp available from Analog Devices, Inc. The differential amplifier 604 may compare the detected signal from the photodiode amplifier 214 to the reference signal 216. The detected signal may be the peak amplitude of the control loop pulse 206 or a specified value of the integral of the control loop pulse 206. This detected signal may be held constant after its detection for the duration of the entire active control loop period for each pulse (approximately 50 to 100 ns) and may then be reset for the detection of the next pulse. A predetermined direct current (DC) voltage 610 for maintaining the desired Pockels cell polarization may be added to the PI circuit output 612 to generate a combined output signal 614. When the detected signal is higher than the reference signal 216, a positive error signal may generate a negative PI circuit output signal and vice versa for the case of a detected signal lower than the reference signal 216. Although integration is used for control, the effect from integration is most likely less than that from the proportional gain because the pulse width of the control loop pulse 206 is usually short. For some embodiments, the integrator 606 of the PI circuit 600 may be disabled by adjusting the resistance of resistor R″.

The output of the PID circuit 220 may be coupled to a Pockels cell high voltage (HV) amplifier 222, which may be used to control and adjust a Pockels cell 224 in step 312. As used herein, a Pockels cell may be generally defined as an electro-optic light modulator that controls the polarization of light passing through a crystal based on an electrical drive signal. The crystal may comprise materials such as ammonium dihydrogen phosphate (ADP), potassium dihydrogen phosphate (KDP), or deuterated KDP (D-KDP). In a Pockels cell, phase retardation of light transiting the crystal is directly proportional to the applied electric field. The rise time of a Pockels cell may be about 40 ps to 150 ps, permitting very fast light switching applications. The Pockels cell HV amplifier 222 may have a very small rise time (e.g., <3 ns) to high voltage and an input/output delay of about 35 ns. Such an amplifier may be commercially available from vendors such as Coherent, Inc. or Lasermetrics, Inc. (e.g., the Lasermetrics 5046).

In the PI circuit 600 of FIG. 6, a negative PI circuit output signal may reduce the total voltage sent to the Pockels cell HV amplifier 222, thereby rotating the polarization of the Pockels cell 224 more so that less light is going through. A positive signal at the PI circuit output 612 may have the opposite effect: increasing the voltage to the Pockels cell HV amplifier 222 causing the Pockels cell 224 to allow more light to pass through.

Since the Pockels cell 224 should be modulated before the transmitted pulse 208 reaches the Pockels cell 224 in order to have the desired affect on the laser pulse (i.e., changing the polarization of the transmitted laser pulse), the transmitted pulse 208 may be delayed from reaching the Pockels cell 224 in step 314. The delay in step 314 should be longer than the amount of time taken to detect and process the control loop pulse 206 in the active control loop and execute the Pockels cell adjustment. Because time is equal to distance divided by speed (the magnitude of velocity) (t=d/| v̅|), any suitable means for increasing the distance the laser pulse must travel, slowing down the speed at which the laser pulse travels, or both may be used as a beam delay 226. For example, the beam delay 226 may consist of an optical material through which the transmitted pulse 208 will travel more slowly than air, such as glass or diamond. For example, with an index of 1.5 for glass, the delay time may be increased by nearly 50% by inserting a glass medium almost as long as the optical path for the transmitted pulse 208 between the beam splitter 204 and the Pockels cell 224.

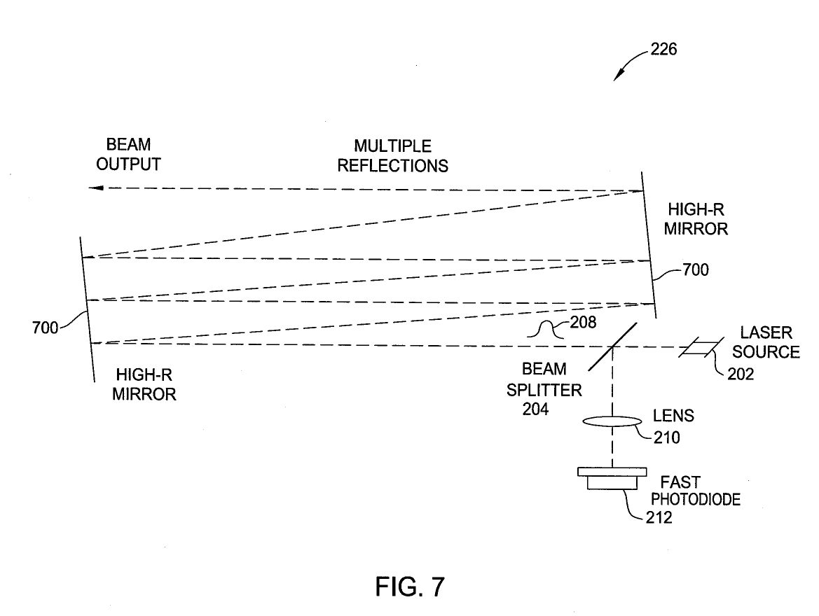

For some embodiments as illustrated in FIG. 7, the beam delay 226 may comprise two or more high-reflectivity mirrors 700 positioned to reflect the transmitted pulse 208 a desired number of times, thereby increasing the optical path length and delaying the arrival of the transmitted pulse at the Pockels cell 224. Since light travels approximately 1 foot per nanosecond in air, the desired optical delay may be used to calculate the desired optical path length and position the mirrors 700 accordingly. The angle of the mirrors 700 with respect to one another and to the incoming transmitted pulse 208 may affect the number of reflections, and the spacing between the mirrors 700 may affect the optical path length of each reflection.

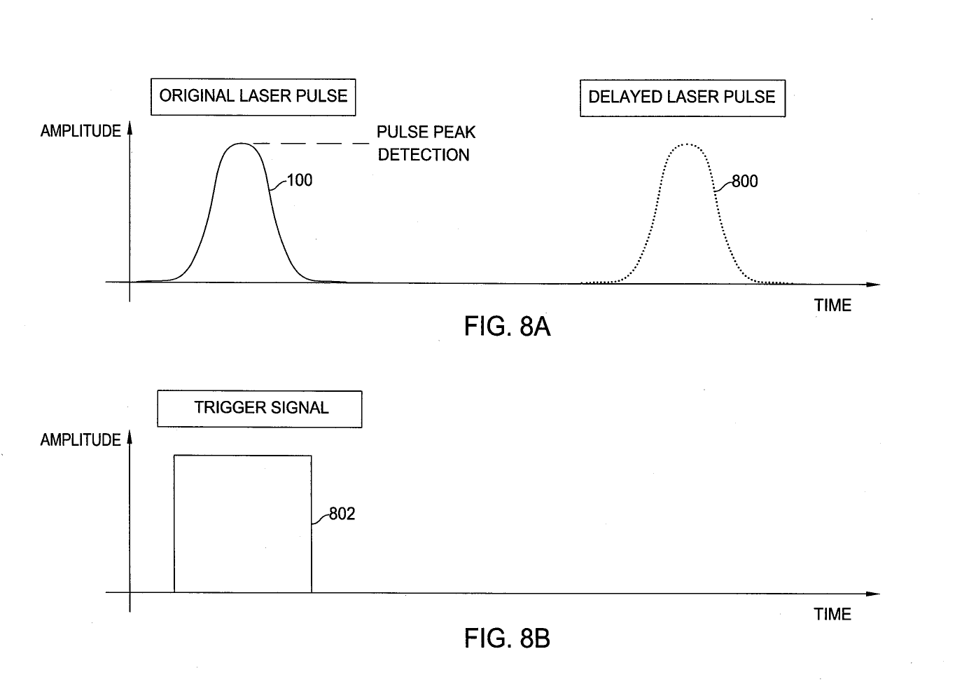

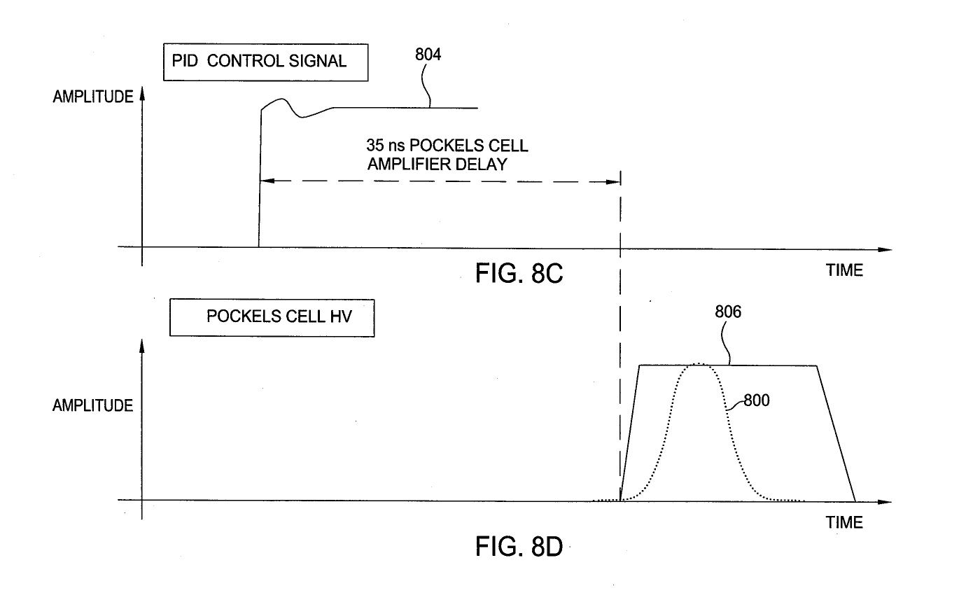

The timing diagrams of FIGS. 8A-D illustrate the timing relationships between the beam delay 226 and the active control loop for one example embodiment. In FIG. 8A the original laser pulse 100 output by the laser source 202 is portrayed along with a delayed laser pulse 800. The trigger pulse 802 in FIG. 8B may be generated with a threshold-crossing circuit 500 receiving a detected signal from the fast photodiode 212. The PID control loop may begin to operate as soon as the trigger pulse 802 (or the pulse peak detection signal) is available as shown in FIG. 8C. After the proportional-integral-derivative (PID) signal 804 begins to rise, the Pockels cell HV amplifier 222 may start to work. The signal from the Pockels cell HV amplifier 222 may have a rise time of 3 ns and an output delay of about 35 ns if the Lasermetrics 5046 amplifier is used. Therefore, for the Pockels cell HV amplifier 222 to fully adjust its voltage to control the transmitted pulse 208, the transmitted pulse 208 should be delayed at least 35 ns+3 ns rise time+half the pulse width. The rise times of the PID circuit 220, the photodiode 212, and the photodiode amplifier 214 may be very fast and may be controlled to be less than 1 to 2 ns. For a 40 ns pulse width, the beam delay 226 should delay the transmitted pulse 208 at least 58 ns. Using a distance of about 8 feet between the mirrors 700 of FIG. 7, the mirrors 700 may be positioned and angled for six reflections (3 reflections on each mirror) as shown. Assuming a mirror reflection loss of 0.25%, the energy loss by the six reflections on the mirror is about 1.5%. The Pockels cell HV amplifier signal 806 is illustrated in FIG. 8D coinciding with the delayed laser pulse 800.

Once the Pockels cell 224 has been modulated, the delayed transmitted laser pulse may be transmitted through the Pockels cell 224 and a polarizing beam splitter (PBS) 228 in step 316 to adjust the energy level of the transmitted pulse 208. Excess energy may be transmitted from the PBS 228 to an optical beam dump (not shown) to absorb the optical energy. The output energy-adjusted pulse may be steered by mirrors, fiber optics, or other suitable optical equipment known to those skilled in the art onto a surface of the substrate 230 to be annealed or otherwise processed. In this manner, subsequent pulses may be adjusted by the active control loop.

The PBS 228 may be set at the cross-polarization with respect to the laser source polarization. The Pockels cell 224 may rotate the incoming laser polarization by 90° when the voltage V_{1/2} is applied, and lets the light go through without any attenuation. V_{1/2} is the voltage applied to the Pockels cell for a 180° phase shift. However, when a different voltage V other than V_{1/2} is applied to the Pockels cell 224, the transmitted pulse 208 may be attenuated when transmitted through the Pockels cell/PBS combination 224, 228 based on the following formula:

$$transmission = {sin}^{2} ( \frac{{90}^{∘} * V}{{V}_{\frac{1}{2}}} )$$

For some embodiments, the voltage V applied to the Pockels cell 224 may be determined by the PI circuit output 612, and V may be used to attenuate the light energy when the detected signal is determined to be different than the reference signal 216. Now referring back to FIG. 6, the fixed DC voltage 610 may be set to V_{1/2} and may be summed with the PI circuit output 612 to yield the combined output signal 614 for the desired attenuation of the transmitted pulse 208.

The reference signal 216 may be established by first detecting, recording, and evaluating control loop pulses 206 on the detection equipment, such as the high-speed photodiode 212, for a period of time. Then, the minimum or a specified signal level may be considered as the reference signal 216. In this manner, the PID circuit 220 may guarantee that transmitted pulses 208 with signal levels the same as the reference signal 216 will be transmitted through the Pockels cell/PBS combination 224, 228 without attenuation, whereas transmitted pulses 208 with greater energy should be attenuated to the reference signal level.

The nanosecond electronic circuit rise times and optical path delays may be sensitive to temperature. Therefore, the active laser pulse energy control system as described above may be operated in a temperature-controlled environment to prevent potential timing problems from fluctuating temperatures. Similarly, the electronic circuits and optical layout should be designed for a specific operating temperature range.

While the foregoing is directed to embodiments of the present invention, other and further embodiments of the invention may be devised without departing from the basic scope thereof, and the scope thereof is determined by the claims that follow.

1. A method of sourcing a plurality of laser pulses having substantially the same energy, the method comprising:
a) providing a series of input laser pulses;
b) splitting one of the series of input laser pulses into a control loop pulse and a transmitted pulse;
c) detecting the control loop pulse;
d) comparing the detected control loop pulse with a reference signal;
e) modulating a Pockels cell based on the comparison;
f delaying the transmitted pulse from reaching the Pockels cell by a delay greater than an amount of time taken in steps c-e plus about half a pulse width of the plurality of laser pulses;
g) transmitting the delayed transmitted pulse through the modulated Pockels cell and a polarizing beam splitter (PBS) to provide an adjusted output pulse; and
h) repeating steps b-g for each remaining input laser pulse in the series of input laser pulses such that each of the adjusted output pulses has substantially the same energy.

2. The method of claim 1, wherein the adjusted output pulses have substantially the same energy within a pulse-to-pulse variation of less than 2%.

3. The method of claim 1, wherein the pulse width is between about 5 ns to 40 ns.

4. The method of claim 1, wherein detecting the control loop pulse comprises employing a high-speed photodiode coupled to an amplifier.

5. The method of claim 1, wherein comparing the detected control loop pulse with the reference signal comprises:
integrating the detected control loop pulse and determining when the integral crosses a threshold value;
determining a peak value of the detected control loop pulse and comparing the peak value with the reference signal; or
determining a signal amplitude of the detected control loop pulse at a certain time and comparing the signal amplitude at the certain time with the reference signal.

6. The method of claim 1, wherein comparing the detected control loop pulse with the reference signal comprises employing a proportional-integral-derivative (PID) control circuit.

7. The method of claim 1, wherein modulating the Pockels cell comprises triggering a Pockels cell high voltage (HV) amplifier coupled to the Pockels cell.

8. The method of claim 1, wherein delaying the transmitted pulse comprises:
positioning two or more mirrors to reflect the transmitted pulse multiple times, thereby increasing an optical path length for the transmitted pulse; and/or
sending the transmitted pulse through an optical material in which light travels more slowly than in air.

9. An apparatus comprising:
a laser source for providing a plurality of laser pulses;
a beam splitter coupled to the laser source to provide a transmission optical path and a control loop optical path;
an active control circuit coupled to the beam splitter along the control loop optical path;
a means for delaying the plurality of pulses coupled to the beam splitter along the transmission optical path; and
a Pockels cell coupled to the pulse delay means and controlled by the active control circuit such that the delayed plurality of pulses are adjusted to have substantially the same energy upon exiting the Pockels cell.

10. The apparatus of claim 9, wherein the plurality of laser pulses have a pulse width between about 5 to 40 ns.

11. The apparatus of claim 9, wherein the plurality of adjusted pulses have substantially the same energy within a pulse-to-pulse variation of less than 2%.

12. The apparatus of claim 9, wherein the active control circuit comprises an optical detector coupled to the beam splitter along the control loop optical path.

13. The apparatus of claim 12, wherein the optical detector comprises a high-speed photodiode and an amplifier.

14. The apparatus of claim 12, further comprising a lens coupled to the optical detector and the beam splitter along the control loop optical path.

15. The apparatus of claim 12, wherein the active control circuit comprises:
a proportional-integral-derivative (PID) circuit coupled to the optical detector; and/or
a threshold-crossing circuit coupled to the optical detector.

16. The apparatus of claim 9, wherein the active control circuit comprises a Pockels cell high voltage (HV) amplifier coupled to the Pockels cell.

17. The apparatus of claim 9, wherein the pulse delay means comprises:
an optical material through which light travels more slowly than in air; and/or
two or more mirrors positioned to reflect a pulse multiple times, thereby increasing an optical path length for the pulse.

18. The apparatus of claim 9, further comprising a polarizing beam splitter (PBS) coupled to the Pockels cell.

19. A pulsed laser annealing system, comprising:
a laser source for providing a plurality of laser pulses;
a beam splitter coupled to the laser source to provide a transmission optical path and a control loop optical path;
an active control circuit coupled to the beam splitter along the control loop optical path;
a means for delaying the plurality of pulses coupled to the beam splitter along the transmission optical path;
a Pockels cell coupled to the pulse delay means and controlled by the active control circuit such that the delayed plurality of pulses are adjusted to have substantially the same energy upon exiting the Pockels cell; and
a pedestal for supporting a substrate to be annealed by the adjusted plurality of pulses.

20. The system of claim 19, further comprising one or more mirrors positioned to steer the adjusted plurality of pulses to the pedestal.
